(19) United States
(12) Patent Application Publication
(10) Pub. No.: US 2023/0043819 A1
(43) Pub. Date: Feb. 9, 2023

(54) BATTERY MODULE AND BATTERY PACK INCLUDING THE SAME

(71) Applicants: Hyundai Motor Company, Seoul (KR); Kia Corporation, Seoul (KR)

(72) Inventors: Yu Ri OH, Hwaseong-si (KR); Woo Young CHOI, Anyang-si (KR); Ji Woong JUNG, Anyang-si (KR); Gyung Hoon SHIN, Seoul (KR); Ju Hyeok PARK, Incheon (KR); Woo Chan LEE, Hwaseong-si (KR); Hae Kyu LIM, Bucheon-si (KR); Tae Hyuck KIM, Asan-si (KR)

(73) Assignees: Hyundai Motor Company, Seoul (KR); Kia Corporation, Seoul (KR)

(21) Appl. No.: 17/728,401

(22) Filed: Apr. 25, 2022

(30) Foreign Application Priority Data
Aug. 5, 2021 (KR) 10-2021-0103412

(51) Int. Cl. H01M 10/48; H01M 50/258; H01M 10/613; H01M 10/625; H01M 10/6556

(52) U.S. Cl. CPC H01M 10/486; H01M 50/258; H01M 10/613; H01M 10/625; H01M 10/6556; H01M 2220/20

(57) ABSTRACT

A battery module and a battery pack including the same are provided. Battery cells are manufactured in the form of a module, and thus, even when the specifications of the battery pack are changed depending on a vehicle kind, the standardized battery cells are applicable to battery packs having various specifications and a separate design process for disposing the battery cells in the battery pack may be omitted, thereby reducing the development period and costs of a new battery pack. Further, plural temperature sensors configured to measure the temperatures of the battery cells are provided so as to provide the optimum environment to the battery cells, and the respective temperature sensors may not be located inside the battery module so as to be easily managed. Moreover, surface pressure performance due to end plates may be secured even when the temperature sensors are located outside the battery module.

### CROSS-REFERENCE TO RELATED APPLICATION

This application claims the benefit of priority to Korean Patent Application No. 10-2021-0103412, filed on Aug. 5, 2021 in the Korean Intellectual Property Office, the disclosure of which is incorporated herein by reference in its entirety.

### BACKGROUND

### 1. Technical Field

The present disclosure relates to a battery module in which a plurality of temperature sensors configured to measure the temperatures of battery cells is provided so as to provide the optimum environment to the battery cells through accurate temperature measurement of the battery cells, the respective temperature sensors are not located inside the battery module so as to be easily managed, and surface pressure performance is secured by end plates even when the temperature sensors are located outside the battery module, and a battery pack including the same.

### 2. Description of the Related Art

Recently, in order to follow the global trend of reduction in carbon dioxide emissions, instead of typical internal combustion engine vehicles which generate driving force through combustion of fossil fuels, demand for electric vehicles which generate driving force due to driving of a motor using electric energy stored in an energy storage device, such as a battery, is rapidly increasing.

The performance of an electric vehicle greatly depends on the capacity and performance of a battery corresponding to an energy storage device configured to store electric energy to be supplied to a motor.

The battery for vehicles configured to store electric energy to be supplied to the motor so as to generate the driving force of the vehicle needs to have excellent electrical characteristics, such as excellent charging and discharging performance, a long service life, etc., and needs to secure high mechanical performance so as to be strong to severe driving environments of the vehicle, such as high temperature, high vibration, etc.

Further, in view of vehicle manufacturers, it is advantages to configure battery hardware in the form of a module having a standardized size or capacity so as to be universally applied to various kinds of vehicles.

The above information disclosed in the Background section is only for enhancement of understanding of the background of the disclosure and should not be interpreted as conventional technology that is already known to those skilled in the art.

### SUMMARY

Therefore, the present disclosure has been made in view of the above problems, and according to various aspects of the present disclosure, a battery module which has a standardized size and capacity so as to be universally applied to various kinds of vehicles, allows a plurality of temperature sensors to measure the temperatures of battery cells so as to provide the optimum environment to the battery cells through accurate temperature measurement of the battery cells, prevents the respective temperature sensors from being located inside the battery module so as to be easily managed, and secures surface pressure performance due to end plates even when the temperature sensors are located outside the battery module, and a battery pack including the same may be provided.

In accordance with an aspect of the present disclosure, the above and other objects can be accomplished by the provision of a battery module that may include a plurality of battery cells stacked to form a stacked structure and end plates respectively disposed to surface contact two side ends of the stacked structure, and upper temperature sensors and lower temperature sensors configured to measure temperatures of the battery cells and disposed on the side ends of the stacked structure, respectively, so as to be spaced apart from each other in upward and downward directions. Parts of the end plates receiving the upper temperature sensors and the lower temperature sensors do not interfere with the upper temperature sensors and the lower temperature sensors, and cover some parts or entireties of the upper temperature sensors and the lower temperature sensors.

The upper temperature sensors may be installed at an upper end of the stacked structure so as to measure temperatures of upper ends of the battery cells, and the lower temperature sensors may be installed at a lower end of the stacked structure so as to measure temperatures of lower ends of the battery cells.

An upper wire electrically, connected to each of the upper temperature sensors, and a lower wire, electrically connected to each of the lower temperature sensors, may each extend towards one side of a corresponding one of the end plates.

A first clamp may be disposed above the stacked structure to traverse the stacked structure so as to be combined with the end plates, a second clamp may be disposed below the stacked structure to traverse the stacked structure so as to be combined with the end plates, each of the upper temperature sensors may be located at a remaining side of the corresponding one of the end plates based on the first clamp, and each of the lower temperature sensors may be located at the one side of the corresponding one of the end plates opposite a corresponding one of the upper temperature sensors based on the second clamp.

The upper wire may be withdrawn upwards from each of the upper temperature sensors, may pass outside or above the first clamp and may extend towards the one side of the corresponding one of the end plates, and the lower wire may be withdrawn laterally from each of the lower temperature sensors and may extend towards the one side of the corresponding one of the end plates.

Each of the end plates may include an inner plate having an insulating material and disposed to surface contact the stacked structure, and an outer plate disposed outside the inner plate, disposed to cover the inner plate, and having higher rigidity than the inner plate.

The inner plate may include an upper cut part by cutting out a part of the inner plate receiving a corresponding one of the upper temperature sensors, and a lower cut part by cutting out a part of the inner plate receiving a corresponding one of the lower temperature sensors.

The outer plate may include an upper installation space at a part of the outer plate receiving the corresponding one of the upper temperature sensors, spaced apart from the stacked structure and configured to enable a corresponding one of the upper temperature sensors to be placed therein.

The outer plate may further include a lower installation space at a part of the outer plate receiving the corresponding one of the lower temperature sensors, spaced apart from the stacked structure and configured to enable a corresponding one of the lower temperature sensors to be placed therein.

The stacked structure may be coupled with bus bar assemblies configured to connect electrodes of the battery cells to each other, and a cover may be configured to cover an upper surface of the stacked structure and upper surfaces of the bus bar assemblies.

The cover may include insertion spaces by cutting parts of the cover receiving the upper temperature sensors in a state in which the cover is combined with the stacked structure.

In accordance with another aspect of the present disclosure, a battery pack may include a battery module having a plurality of battery cells stacked to form a stacked structure, end plates respectively disposed to surface contact two side ends of the stacked structure, and upper temperature sensors and lower temperature sensors configured to measure temperatures of the battery cells and disposed on at the side ends of the stacked structure so as to be spaced apart from each other in upward and downward directions. Parts of the end plates receiving the upper temperature sensors and the lower temperature sensors do not interfere with the upper temperature sensors and the lower temperature sensors. The battery pack may further include a case in which the battery module is seated.

The case may include a seating surface on which the battery module is seated, and a cooling channel in which a cooling medium flows may be disposed under the seating surface.

An upper wire for electrical connection may be connected to an upper part of each of the upper temperature sensors.

A lower wire for electrical connection may be connected to each of the lower temperature sensors in a length direction of the stacked structure.

Each of the end plates may include an inner plate including an insulating material and disposed to surface contact the stacked structure, and an outer plate disposed outside the inner plate, disposed to cover the inner plate, and having higher rigidity than the inner plate.

The inner plate may include an upper cut part by cutting out a part of the inner plate receiving a corresponding one of the upper temperature sensors, and a lower cut part by cutting out a part of the inner plate receiving a corresponding one of the lower temperature sensors.

The outer plate may include an upper installation space at a part of the outer plate receiving the corresponding one of the upper temperature sensors, spaced apart from the stacked structure and configured to enable a corresponding one of the upper temperature sensors to be placed therein, and a lower installation space at a part of the outer plate receiving the corresponding one of the lower temperature sensors, spaced apart from the stacked structure and configured to enable a corresponding one of the lower temperature sensors to be placed therein.

The stacked structure may be coupled with bus bar assemblies configured to connect electrodes of the battery cells to each other, and a cover may be configured to cover an upper surface of the stacked structure and upper surfaces of the bus bar assemblies.

The cover may include insertion spaces by cutting parts of the cover receiving the upper temperature sensors in a state in which the cover is combined with the stacked structure.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view of a battery module according to the present disclosure;

FIG. 2 is an exploded perspective view of the battery module shown in FIG. 1;

FIG. 3 is an exploded perspective view illustrating the structure of a cell assembly according to one embodiment of the present disclosure;

FIG. 4 is a perspective view illustrating end plates of the battery module according to one embodiment of the present disclosure;

FIG. 5 is a perspective view illustrating installation of an upper temperature sensor in the battery module according to one embodiment of the present disclosure;

FIG. 6 is a view illustrating an outer plate of the battery module according to one embodiment of the present disclosure;

FIG. 7 is a view illustrating an inner plate of the battery module according to one embodiment of the present disclosure; and

FIG. 8 is a cross-sectional view illustrating a portion of a battery pack in which the battery module according to one embodiment of the present disclosure is placed.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

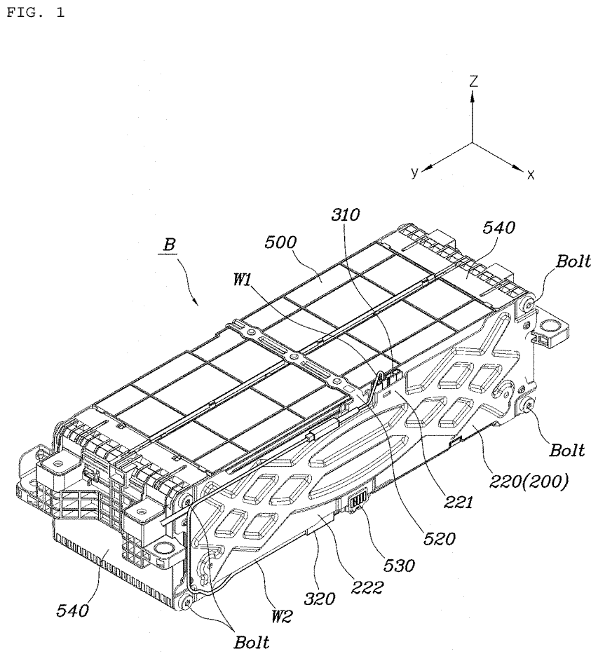

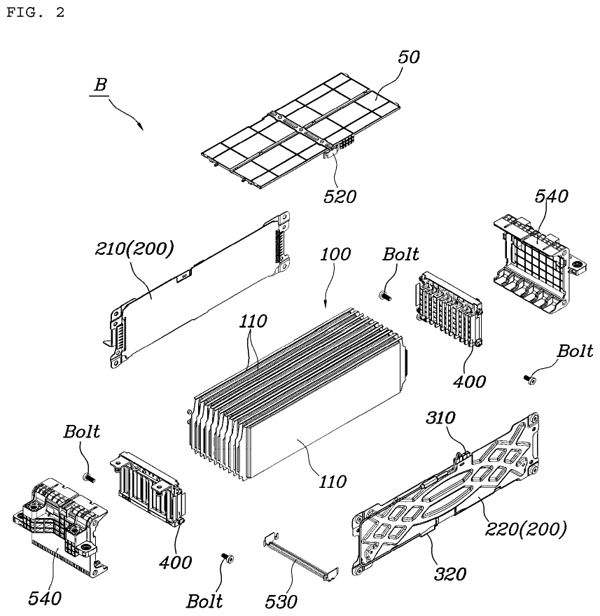

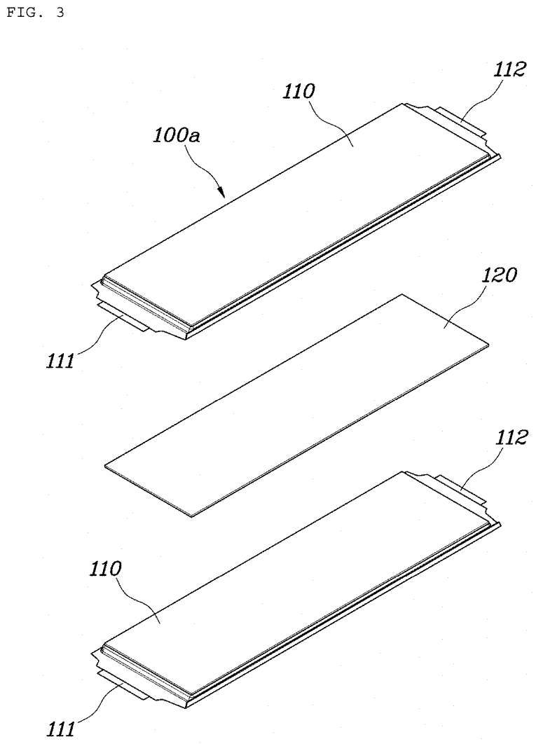

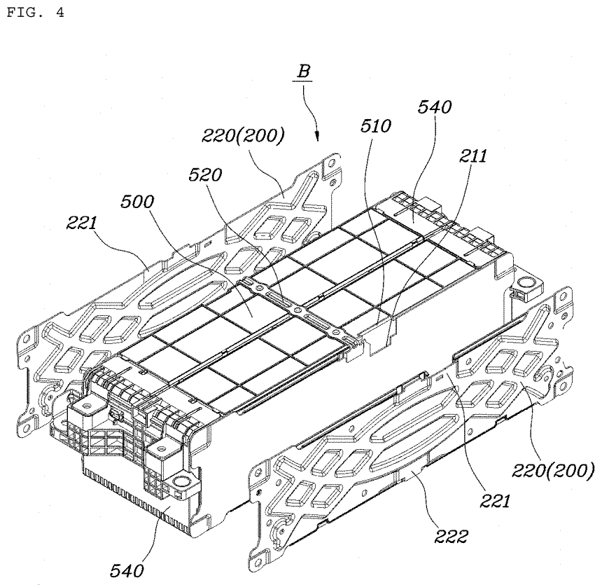

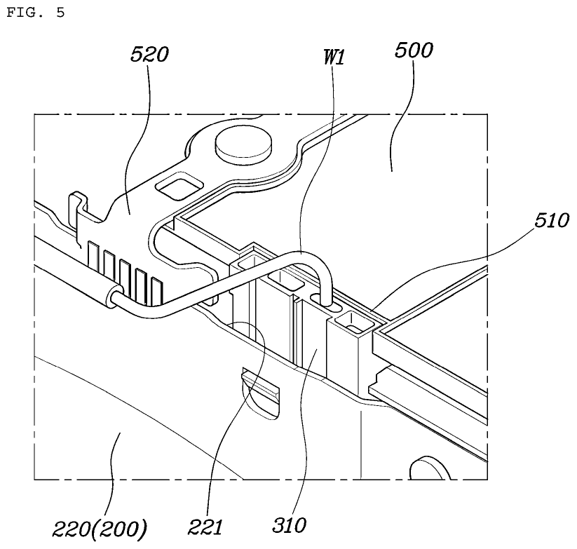

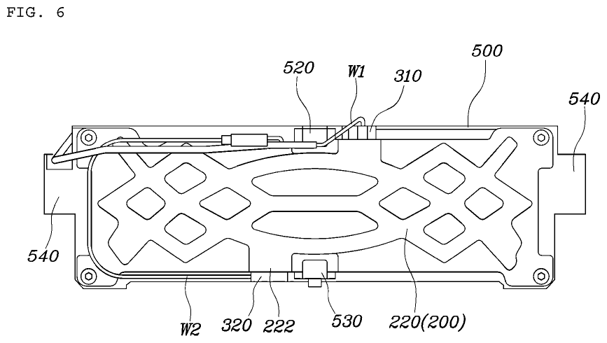

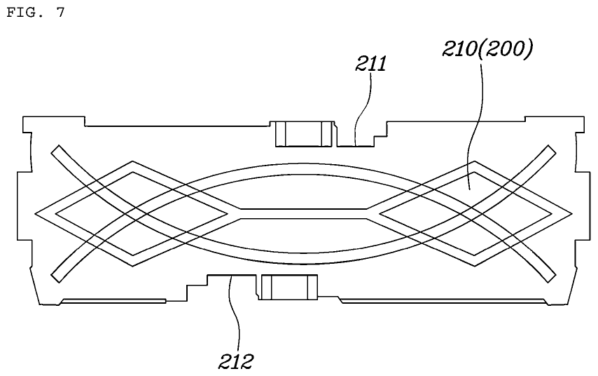

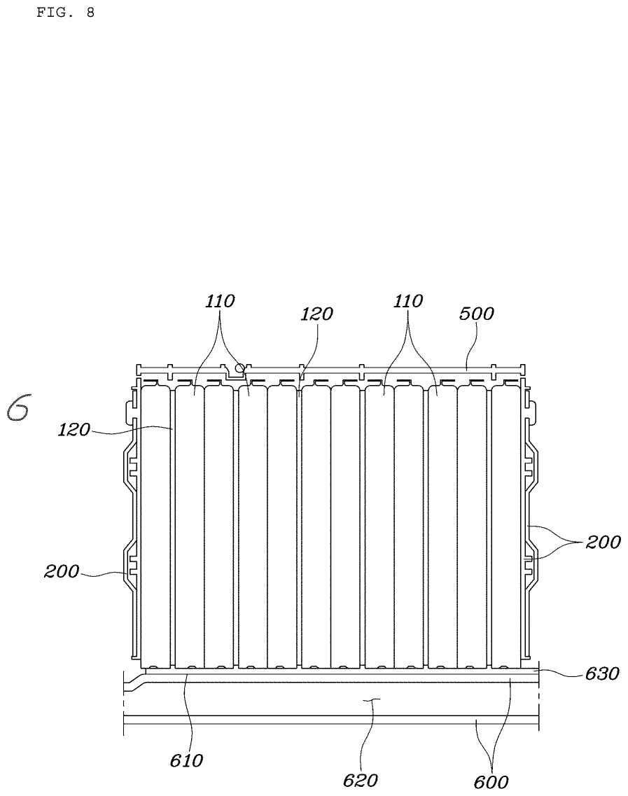

FIG. 1 is a perspective view of a battery module according to the present disclosure, FIG. 2 is an exploded perspective view of the battery module shown in FIG. 1, FIG. 3 is an exploded perspective view illustrating the structure of a cell assembly according to one embodiment of the present disclosure, FIG. 4 is a perspective view illustrating end plates of the battery module according to one embodiment of the present disclosure, FIG. 5 is a perspective view illustrating installation of an upper temperature sensor in the battery module according to one embodiment of the present disclosure, FIG. 6 is a view illustrating an outer plate of the battery module according to one embodiment of the present disclosure, FIG. 7 is a view illustrating an inner plate of the battery module according to one embodiment of the present disclosure, and FIG. 8 is a cross-sectional view illustrating a portion of a battery pack in which the battery module according to one embodiment of the present disclosure is placed.

As shown in FIGS. 1 and 2, a battery module B according to the present disclosure is configured such that a plurality of battery cells 110 is stacked to form a stacked structure 100 and end plates 200 are respectively provided to come into surface contact with both side ends of the stacked structure 100.

Further, the stacked structure 100 is coupled with bus bar assemblies 400 configured to connect electrodes of the battery cells 110 to each other, and a cover 500 configured to cover the upper surface of the stacked structure 100 and the upper surfaces of the bus bar assemblies 400.

That is, referring to FIGS. 1 and 2, in the battery module B according to one embodiment of the present disclosure, a plurality of the battery cells 110 is stacked in the X-axis direction to form the stacked structure 100.

A pair of the end plates 200 is provided so as to come into surface contact with both side ends of the stacked structure 100 in the X-axis direction, and a pair of the bus bar assemblies 400 configured to connect the electrodes of the battery cells 110 to each other is provided at both ends of the stacked structure 100 in the Y-axis direction perpendicular to the X-axis direction.

Further, the cover 500 configured to cover the upper surface of the stacked structure 100 is provided on the stacked structure 100 in the Z-axis direction perpendicular to the X-axis direction and the Y-axis direction. Here, a first clamp 520 may be provided above the cover 500 to traverse the cover 500 so as to be combined with the end plates 200 provided in a pair, and a second clamp 530 may be provided below the cover 500 to traverse the cover 500 so as to be combined with the end plates 200.

In addition, the cover brackets 540 configured to respectively cover the stacked structure 100 formed by stacking the battery cells 110 in the Y-axis direction may be further provided outside the bus bar assemblies 400.

Further, as shown in FIG. 3, the stacked structure 100 formed by stacking the battery cells 110 may include a plurality of cell assemblies 100a, each of which includes two battery cells 110 and a surface pressure pad 120 interposed between the two battery cells 110. As such, the stacked structure 100 may be manufactured by stacking a plurality of the cell assemblies 100a, each of which includes the two battery cells 110 and the surface pressure pad 120 interposed between the two battery cells 110.

In the cell assembly 100a, the respective battery cells 110 may be disposed such that the electrodes of the battery cells 110 having the same polarity, for example, cathodes 111 or anodes 112, are adjacent to each other.

Further, in the stacked structure 100, the respective cell assemblies 100a are stacked such that the electrodes of the cell assemblies 100a having different polarities are adjacent to each other. The reason for this is to establish electrical connection relations of direct current between the cell assemblies 100a when the bus bars of the bus bar assemblies 400 and the electrodes of the battery cells 110 are connected to each other. That is, the battery cells 110 in each cell assembly 100a may form mutually electrical series connection relations, and the cell assemblies 100a may form electrical series connection relations.

The surface pressure pads 120 serve to provide elasticity and thus to prevent deformation of the structure of the battery module B when the battery cells 110 are swollen.

Further, the cell assemblies 100a may be mutually stacked by interposing a hot melt therebetween. The hot melt, which is a kind of liquid adhesive which has an adhesive property when heat is applied thereto, may be applied to the surfaces of the battery cells 110 in a predetermined pattern before the cell assemblies 100a are mutually stacked, and may implement a desired location relation between the battery cells 110 by aligning the stacked battery cells 110 and simultaneously applying heat thereto.

Further, as shown in FIG. 1, upper temperature sensors 310 and lower temperature sensors 320 configured to measure the temperatures of the battery cells 110 may be provided at the side ends of the stacked structure 100 so as to be spaced apart from each other in the upward and downward directions.

A plurality of battery modules B may be disposed in a case 600 designed to fit a vehicle type, so as to implement one battery pack. In order to manage the battery pack, it is very important to check the inner temperature of the battery pack, and thus, the battery module B is generally manufactured in a form in which temperature sensors are installed inside the battery module B. However, the battery module B according to the present disclosure is configured such that temperature sensors are not installed inside the battery module B but are installed outside the battery module B.

Therefore, the upper temperature sensors 310 and the lower temperature sensors 320 are provided at the side ends of the stacked structure 100, the upper temperature sensors 310 are installed at the upper end of the stacked structure 100 so as to measure the temperatures of the upper ends of the battery cells 110, and the lower temperature sensors 320 are installed at the lower end of the stacked structure 100 so as to measure the temperatures of the lower ends of the battery cells 110.

That is, the upper temperature sensors 310 and the lower temperature sensors 320 may measure the temperatures of the outermost battery cells 110 among the battery cells 110, and the temperatures of the battery cells 110 may be accurately detected through a temperature deviation acquired by collecting the temperature information of the battery cells 110 respectively measured by the upper temperature sensors 310 and the lower temperature sensors 320.

Further, as shown in FIG. 4, the end plates 200 provided in a pair are respectively disposed on both side surfaces of the stacked structure 100 formed by stacking the battery cells 110 in the X-axis direction, and come into surface contact with the exposed surfaces of the outermost battery cells 110 among the battery cells 110.

The end plates 200 are elements which maintain a constant gap therebetween so as to prevent deformation of the battery module B through rigidity thereof and to maintain uniform surface pressure between the stacked battery cells 110 when the battery cells 110 are swollen. Therefore, the end plates 200 needs to have a sufficient rigidity so as to prevent deformation of the battery module B while maintaining surface contact between the battery cells 110, and may include an additional unit configured to uniformize the surface pressure.

Particularly, the end plates 200 are provided such that parts of the end plates 200 receiving the upper temperature sensors 310 and the lower temperature sensors 320 do not interfere with the upper temperature sensors 310 and the lower temperature sensors 320, and cover some parts or the entireties of the upper temperature sensors 310 and the lower temperature sensors 320, in the state in which the end plates 200 come into surface contact with the stacked structures 100.

That is, in the battery module B according to the present disclosure, the upper temperature sensors 310 and the lower temperature sensors 320 are installed at the outermost side ends of the stacked structures 100, and thus, the end plates 200 may interfere with the upper temperature sensors 310 and the lower temperature sensors 320 when the end plates 200 are mounted on the stacked structure 100. Here, because the end plates 200 need to maintain surface pressure performance with respect to the stacked structure 100 formed by stacking the battery cells 110, the end plates 200 must be pressed against the stacked structure 100.

Therefore, the end plates 200 are provided such that parts of the end plates 200 receiving the upper temperature sensors 310 and the lower temperature sensors 320 do not interfere with the upper temperature sensors 310 and the lower temperature sensors 320, and cover some parts or the entireties of the upper temperature sensors 310 and the lower temperature sensors 320 so as to secure a contact area with the battery cells 110 and to protect the upper temperature sensors 310 and the lower temperature sensors 320.

Further, as shown in FIG. 1, an upper wire W1 electrically connected to each of the upper temperature sensors 310 and a lower wire W2 electrically connected to each of the lower temperature sensors 320 may be respectively withdrawn towards one side of a corresponding one of the end plates 200, and may extend along the corresponding end plate 200.

As such, the upper wire W1 and the lower wire W2 extend from the bus bar assembly 400 or the cover bracket 540 provided at one side of the end plate 200 towards the other side, and are respectively connected to the upper temperature sensor 310 and the lower temperature sensor 320. In this way, the upper wire W1 and the lower wire W2 extend towards one side of the stacked structure 100, thus being capable of simplifying an electrical connection structure.

Therefore, the upper wire W1 connected to the upper temperature sensor 310 and the lower wire W2 connected to the lower temperature sensor 320 are withdrawn towards one side of the stacked structure 100, i.e., in the same direction, thereby simplifying the electrical connection structure and securing convenience in assembly and maintenance.

Further, the first clamp 520 is provided above the stacked structure 100 to traverse the stacked structure 100 so as to be combined with the end plates 200, and the second clamp 530 is provided below the staked structure 100 to traverse the stacked structure 100 so as to be combined with the end plates 200. The first clamp 520 and the second clamp 530 are disposed at the center of the stacked structure 100, and provide uniform clamping pressure to a pair of the end plates 200.

Here, the upper temperature sensor 310 is located at the other side of the end plate 200 based on the first clamp 520, and the lower temperature sensor 320 may be located at the side of the end plate 200 opposite the upper temperature sensor 310 based on the second clamp 530.

As such, by disposing the upper temperature sensor 310 and the lower temperature sensor 320 at the opposite sides based on the first clamp 520 and the second clamp 530 in a diagonal direction, surface pressure applied due to the shape of the end plates 200 may be uniformly dispersed to upper and lower regions. Further, the upper temperature sensor 310 and the lower temperature sensor 320 are disposed close to the center of the stacked structure 100, and thus improve accuracy in measurement of the temperatures of the battery cells 110 through the upper temperature sensor 310 and the lower temperature sensor 320.

The upper wire W1 is withdrawn upwards from the upper temperature sensor 310, passes outside or above the first clamp 520 and extends towards one side of the end plate 200, and the lower wire W2 is withdrawn laterally from the lower temperature sensor 320 and extends towards the side of the end plate 200.

That is, as shown in FIGS. 1 and 5, the upper wire W1 for electrical connection is connected to the upper temperature sensor 310, and the upper wire W1 is connected to the upper part of the upper temperature sensor 310 so as to be withdrawn upwards therefrom.

As the upper wire W1 is connected to the upper temperature sensor 310 so as to be withdrawn upwards therefrom, the end plate 200 does not requires a space for the upper wire W1 in addition to a space for the upper temperature sensor 310. The direction of withdrawing the upper wire W1 from the upper temperature sensor 310 is the Z-axis direction, and thus avoids interference of the upper wire W1 with the end plate 200.

That is, in order to secure the surface pressure, the end plates 200 need to secure the contact surface with the battery cells 110. Therefore, the upper wire W1 connected to the upper temperature sensor 310 is withdrawn upwards, and thereby, the end plate 200 requires no space for the upper wire W1 and thus the contact area between the end plate 200 and the battery cell 110 may be secured.

Further, in the state in which the upper wire W1 is withdrawn upwards from the upper temperature sensor 310, the upper wire W1 passes outside or above the first clamp 520 and extends towards one side of the end plate 200, and the lower wire W2 is withdrawn laterally from the lower temperature sensor 320 and extends towards the side of the end plate 200, and thereby, the upper wire W1 extends along the same path as the lower wire W2, thus simplifying an electrical connection structure and avoiding interference with the first clamp 520.

Further, as shown in FIGS. 1 and 6, the lower wire W2 for electrical connection is connected to the lower temperature sensor 320, and the lower wire W2 is withdrawn laterally from the lower temperature sensor 320 and extends towards one side of the end plate 200.

As the lower wire W2 is withdrawn from the lower temperature sensor 320 in the length direction of the end plate 200, interference of the lower wire W2 with other parts and damage to the lower wire W2 thereby are avoided. Here, the direction of withdrawing the lower wire W2 from the lower temperature sensor 320 is the Y-axis direction.

That is, the battery module B is placed in the case 600 and, when the lower wire W2 is connected to the lower temperature sensor 320 so as to be withdrawn downwards therefrom in the battery module B, the lower wire W2 may be damaged due to interference with the case 600. Further, when the lower wire W2 is connected to the lower temperature sensor 320 so as to be withdrawn outwards therefrom, the lower wire W2 may interfere with the end plate 200.

Therefore, the lower wire W2 is connected to the lower temperature sensor 320 so as to be withdrawn therefrom in the length direction of the end plate 200, i.e., in the Y-axis direction, and thereby, damage to the lower wire W2 connected to the lower temperature sensor 320 when the battery module B is seated in the case 600 may be prevented and thus the contact area between the end plate 200 and the battery cell 110 may be secured. Further, the lower wire W2 is withdrawn and extends in the same direction as the upper wire W1, thereby improving convenience in assembly and maintenance.

Therefore, in the battery module B according to the present disclosure, even when the upper temperature sensors 310 and the lower temperature sensors 320 are provided, the unusable area of the end plates 200 is minimized by setting the directions of withdrawing the upper wires W1 and the lower wires W2 connected to the upper temperature sensors 310 and the lower temperature sensors 320, and thus, the surface pressure performance of the end plates 200 may be maintained.

Each of the above-described end plates 200 includes an inner plate 210 including an insulating material and configured to come into surface contact with the stacked structure 100, and an outer plate 220 provided outside the inner plate 210 and configured to cover the inner plate 210 and to have higher rigidity than the inner plate 210.

Here, the outer plate 220 may include a metal, such as aluminum, so as to achieve weight reduction while securing sufficient rigidity, and the inner plate 210 may include the insulating material having lower rigidity than the outer plate 220, such as plastic, so as to secure electrical isolation when the end plate 200 comes into contact with the outermost battery cell 110 of the stacked structure 100.

Particularly, as shown in FIG. 7, an upper cut part 211 is formed in the inner plate 210 by cutting out a part of the inner plate 210 receiving the upper temperature sensor 310, and a lower cut part 212 is formed in the inner plate 210 by cutting out a part of the inner plate 210 receiving the lower temperature sensor 320.

As such, the upper cut part 211 and the lower cut part 212 may be formed in the inner plate 210, the upper cut part 211 may be formed to match the upper temperature sensor 310, and the lower cut part 212 may be formed to match the lower temperature sensor 320.

That is, as the inner plate 210 is pressed against the outermost battery cell 110, the inner plate 210 interferes with the upper temperature sensor 310 and the lower temperature sensor 320. Further, because the outer plate 220 comes into contact with the outer surface of the inner plate 210, shape deformation of the inner plate 210 is restricted.

Therefore, the upper cut part 211 is formed at the upper end of the inner plate 210 by cutting out the part of the inner plate 210 receiving the upper temperature sensor 310 and the lower cut part 212 is formed at the lower end of the inner plate 210 by cutting out the part of the inner plate 210 receiving the lower temperature sensor 320, and thus, when the inner plate 210 comes into contact with the outermost battery cell 110, the inner plate 210 may be pressed against the battery cell 110 without interference with the upper temperature sensor 310 and the lower temperature sensor 320.

Further, as shown in FIG. 6, an upper installation space 221 spaced from the stacked structure 100 and configured to enable the upper temperature sensor 310 to be placed therein is formed at a part of the outer plate 220 receiving the upper temperature sensor 310, and a lower installation space 222 spaced from the stacked structure 100 and configured to enable the lower temperature sensor 320 to be placed therein is formed at a part of the outer plate 220 receiving the lower temperature sensor 320.

As such, the upper installation space 221 and the lower installation space 222 are formed on the outer pate 220, the upper installation space 221 is formed by bending the part of the outer plate 220 receiving the upper temperature sensor 310 so as to protrude outwards, and the lower installation space 222 is formed by bending the part of the outer plate 220 receiving the lower temperature sensor 320 so as to protrude outwards.

That is, as the outer plate 220 is disposed to cover the inner plate 210, the outer plate 220 interferes with the upper temperature sensor 310 exposed through the upper cut part 211 of the inner plate 210 and the lower temperature sensor 320 exposed through the lower cut part 212 of the inner plate 210.

Therefore, the upper installation space 221 in which the upper temperature sensor 310 is placed is formed at the upper end of the outer plate 220 by bending the part of the outer plate 220 receiving the upper temperature sensor 310 so as to protrude outwards and the lower installation space 222 in which the lower temperature sensor 320 is placed is formed by bending the part of the outer plate 220 receiving the lower temperature sensor 320 so as to protrude outwards, and thus, when the outer plate 220 is combined with the inner plate 210, the outer plate 220 does not interfere with the upper temperature sensor 310 and the lower temperature sensor 320.

Further, because the upper temperature sensor 310 and the lower temperature sensor 320 are respectively placed in the upper installation space 221 and the lower installation space 222 of the outer plate 220, the upper temperature sensor 310 and the lower temperature sensor 320 are protected by the outer plate 220.

Further, insertion spaces 510 are formed in the cover 500 by cutting parts of the cover 500 receiving the upper temperature sensors 310 in the state in which the cover 500 is combined with the stacked structure 100.

In the battery module B according to the present disclosure, the upper temperature sensors 310 are installed at the upper end of the stacked structure 100, and thus, the upper temperature sensors 310 may interfere with the cover 500.

Therefore, as shown in FIG. 5, the insertion spaces 510 are formed in the cover 500 so as to have the outline shape of the upper temperature sensors 310 by cutting the parts of the cover 500 receiving the upper temperature sensors 310 when the cover 500 is combined with the stacked structure 100, thereby preventing the upper temperature sensors 310 from interfering with the cover 500.

A battery pack according to the present disclosure is configured such that the above-described battery module B is placed in the case 600 of the battery pack, as shown in FIGS. 1 and 8. Here, the bottom surface of the case 600 may be used as a seating surface on which the battery module B is seated.

As described above, the battery module B according to one embodiment of the present disclosure has a structure in which the lower surfaces of the battery cells 110 are exposed without a cover separately disposed under the lower surface of the battery module B in the Z-axis direction. The battery module B may be seated in the case 600 such that the exposed lower surfaces of the battery cells 110 face the seating surface 610 of the case 600. A gap filler 630 fills a gap between the seating surface 610 of the case 600 and the exposed lower surfaces of the battery cells 110 when the battery module B is seated in the case 600, and thus enables the battery cells 110 of the battery module B and the seating surface 610 of the case 600 to come into indirect contact with each other. Here, the gap filler 630 may be a thermal interface material which may transfer heat generated from the battery cells 110 to the case 600.

A cooling channel 620 in which a cooling medium flows may be further provided under the seating surface 610 of the case 600, and may cool the battery cells 110 through heat exchange between the cooling medium and the battery cells 110.

Here, the upper wire W1 for electrical connection may be connected to the upper part of each of the upper temperature sensors 310. Further, the lower wire W2 for electrical connection may be connected to each of the lower temperature sensors 320 in the length direction of the stacked structure 100.

Therefore, in the battery module B according to the present disclosure, even when the upper temperature sensors 310 and the lower temperature sensors 320 are provided, the unusable area of the end plates 200 is minimized by setting the directions of withdrawing the upper wires W1 and the lower wires W2 connected to the upper temperature sensors 310 and the lower temperature sensors 320, and thus, the surface pressure performance of the end plates 200 may be maintained.

Each of the end plates 200 includes the inner plate 210 including an insulating material and configured to come into surface contact with the stacked structure 100, and the outer plate 220 provided outside the inner plate 210 and configured to cover the inner plate 210 and to have higher rigidity than the inner plate 210.

Here, the upper cut part 211 is formed in the inner plate 210 by cutting out the part of the inner plate 210 receiving the upper temperature sensor 310, and the lower cut part 212 is formed in the inner plate 210 by cutting out the part of the inner plate 210 receiving the lower temperature sensor 320.

Further, the upper installation space 221 spaced from the stacked structure 100 and configured to enable the upper temperature sensor 310 to be placed therein is formed at the part of the outer plate 220 receiving the upper temperature sensor 310, and the lower installation space 222 spaced from the stacked structure 100 and configured to enable the lower temperature sensor 320 to be placed therein is formed at the part of the outer plate 220 receiving the lower temperature sensor 320.

Thereby, the inner plate 210 may be pressed against the outermost battery cell 110 without interfering with the upper temperature sensor 310 and the lower temperature sensor 320 due to the upper cut part 211 and the lower cut part 212. Further, because the upper temperature sensor 310 and the lower temperature sensor 320 are respectively placed in the upper installation space 221 and the lower installation space 222 of the outer plate 220, the upper temperature sensor 310 and the lower temperature sensor 320 may be protected by the outer plate 220 without interfering with the outer plate 220.

The stacked structure 100 is coupled with the bus bar assemblies 400 configured to connect the electrodes of the battery cells 110 to each other, and the cover 500 configured to cover the upper surface of the stacked structure 100 and the upper surfaces of the bus bar assemblies 400.

Here, the insertion spaces 510 are formed in the cover 500 by cutting the parts of the cover 500 receiving the upper temperature sensors 310 in the state in which the cover 500 is combined with the stacked structure 100.

That is, the insertion spaces 510 are formed in the cover 500 so as to have the outline shape of the upper temperature sensors 310 by cutting the parts of the cover 500 receiving the upper temperature sensors 310 when the cover 500 is combined with the stacked structure 100, thereby preventing the upper temperature sensors 310 from interfering with the cover 500.

In the battery module B having the above-described structure and the battery pack including the same, the battery cells 110 configured to form the battery pack are manufactured in the form of a module, and thus, even when the specifications of the battery pack are changed depending on the kind of a vehicle, the standardized battery cells 110 may be applied to battery packs having various specifications, and a separate design process for disposing the battery cells 110 in the battery pack may be omitted, thereby being capable of reducing the development period and development costs of a new battery pack.

Further, a plurality of temperature sensors configured to measure the temperatures of the battery cells 110 may be provided so as to provide the optimum environment to the battery cells 110 through accurate temperature measurement of the battery cells 110, and the respective temperature sensors may not be located inside the battery module B so as to be easily managed.

In addition, surface pressure performance due to the end plates 200 may be secured even when the temperature sensors are located outside the battery module B.

As is apparent from the above description, in a battery module having the above-described structure and a battery pack including the same according to the present disclosure, battery cells configured to form the battery pack are manufactured in the form of a module, and thus, even when the specifications of the battery pack are changed depending on the kind of a vehicle, the standardized battery cells may be applied to battery packs having various specifications, and a separate design process for disposing the battery cells in the battery pack may be omitted, thereby being capable of reducing the development period and development costs of a new battery pack.

Further, a plurality of temperature sensors configured to measure the temperatures of the battery cells may be provided so as to provide the optimum environment to the battery cells through accurate temperature measurement of the battery cells, and the respective temperature sensors may not be located inside the battery module so as to be easily managed.

In addition, surface pressure performance due to end plates may be secured even when the temperature sensors are located outside the battery module.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A battery module, comprising:
a plurality of battery cells stacked to form a stacked structure, and end plates respectively disposed to surface contact two side ends of the stacked structure; and
upper temperature sensors and lower temperature sensors configured to measure temperatures of the battery cells and disposed on the side ends of the stacked structure, respectively, the upper and lower temperature sensors being spaced apart from each other in upward and downward directions,
wherein parts of the end plates receiving the upper temperature sensors and the lower temperature sensors do not interfere with the upper temperature sensors and the lower temperature sensors, and cover some parts or entireties of the upper temperature sensors and the lower temperature sensors.

2. The battery module according to claim 1, wherein:
the upper temperature sensors are installed at an upper end of the stacked structure so as to measure temperatures of upper ends of the plurality of battery cells, and
the lower temperature sensors are installed at a lower end of the stacked structure so as to measure temperatures of lower ends of the plurality of battery cells.

3. The battery module according to claim 1, wherein an upper wire, electrically connected to each of the upper temperature sensors, and a lower wire, electrically connected to each of the lower temperature sensors, each extend towards one side of a corresponding one of the end plates.

4. The battery module according to claim 3, wherein:
a first clamp is disposed above the stacked structure to traverse the stacked structure so as to be combined with the end plates, and a second clamp is disposed below the stacked structure to traverse the stacked structure so as to be combined with the end plates,
each of the upper temperature sensors is located at a remaining side of the corresponding one of the end plates based on the first clamp, and
each of the lower temperature sensors is located at the one side of the corresponding one of the end plates opposite a corresponding one of the upper temperature sensors based on the second clamp.

5. The battery module according to claim 4, wherein:
the upper wire is withdrawn upwards from each of the upper temperature sensors, passes outside or above the first clamp and extends towards the one side of the corresponding one of the end plates, and
the lower wire is withdrawn laterally from each of the lower temperature sensors and extends towards the one side of the corresponding one of the end plates.

6. The battery module according to claim 1, wherein each of the end plates comprises an inner plate including an insulating material and disposed to surface contact the stacked structure, and an outer plate disposed outside the inner plate and disposed to cover the inner plate, the outer plate having higher rigidity than the inner plate.

7. The battery module according to claim 6, wherein the inner plate includes an upper cut part by cutting out a part of the inner plate receiving a corresponding one of the upper temperature sensors, and further includes a lower cut part by cutting out a part of the inner plate receiving a corresponding one of the lower temperature sensors.

8. The battery module according to claim 6, wherein the outer plate includes an upper installation space at a part of the outer plate receiving the corresponding one of the upper temperature sensors, the upper installation space being spaced apart from the stacked structure and configured to enable a corresponding one of the upper temperature sensors to be placed therein, and
the outer plate further includes a lower installation space at a part of the outer plate receiving the corresponding one of the lower temperature sensors, the lower installation space being spaced from the stacked structure and configured to enable a corresponding one of the lower temperature sensors to be placed therein.

9. The battery module according to claim 1, further comprising bus bar assemblies coupled with the stacked structure and connecting electrodes of the plurality of battery cells to each other, and a cover covering an upper surface of the stacked structure and upper surfaces of the bus bar assemblies.

10. The battery module according to claim 9, wherein the cover includes insertion spaces by cutting parts of the cover receiving the upper temperature sensors in a state in which the cover is combined with the stacked structure.

11. A battery pack comprising:
a battery module including:
a plurality of battery cells stacked to form a stacked structure, and end plates respectively disposed to surface contact two side ends of the stacked structure;
upper temperature sensors and lower temperature sensors configured to measure temperatures of the battery cells and disposed on the side ends of the stacked structure, respectively, the upper temperature sensors and lower temperature sensors being spaced apart from each other in upward and downward directions,
wherein parts of the end plates receiving the upper temperature sensors and the lower temperature sensors do not interfere with the upper temperature sensors and the lower temperature sensors; and
a case in which the battery module is seated.

12. The battery pack according to claim 11, wherein the case includes a seating surface on which the battery module is seated, and a cooling channel in which a cooling medium flows is disposed under the seating surface of the case.

13. The battery pack according to claim 11, wherein an upper wire for electrical connection is connected to an upper part of each of the upper temperature sensors.

14. The battery pack according to claim 11, wherein a lower wire for electrical connection is connected to each of the lower temperature sensors in a length direction of the stacked structure.

15. The battery pack according to claim 11, wherein each of the end plates comprises an inner plate including an insulating material and disposed to surface contact the stacked structure, and an outer plate disposed outside the inner plate and disposed to cover the inner plate, the outer plate having higher rigidity than the inner plate.

16. The battery pack according to claim 15, wherein the inner plate includes an upper cut part by cutting out a part of the inner plate receiving a corresponding one of the upper temperature sensors, and further includes a lower cut part by cutting out a part of the inner plate receiving a corresponding one of the lower temperature sensors.

17. The battery pack according to claim 15, wherein the outer plate includes an upper installation space at a part of the outer plate receiving the corresponding one of the upper temperature sensors, the upper installation space being spaced apart from the stacked structure and configured to enable a corresponding one of the upper temperature sensors to be placed therein is formed, and
the outer plate further includes a lower installation space at a part of the outer plate receiving the corresponding one of the lower temperature sensors, the lower installation space being spaced apart from the stacked structure and configured to enable a corresponding one of the lower temperature sensors to be placed therein is formed.

18. The battery pack according to claim 11, wherein with the battery module further comprises bus bar assemblies coupled with the stacked structure and connecting electrodes of the plurality of battery cells to each other, and a cover covering an upper surface of the stacked structure and upper surfaces of the bus bar assemblies.

19. The battery pack according to claim 18, wherein the cover includes insertion spaces by cutting parts of the cover receiving the upper temperature sensors in a state in which the cover is combined with the stacked structure.
